(19) United States
(12) Patent Application Publication
(10) Pub. No.: US 2026/0106094 A1
(43) Pub. Date: Apr. 16, 2026

(54) KEYBOARD AND CONSOLE DEVICE

(71) Applicant: FCL COMPONENTS LIMITED, Tokyo (JP)

(72) Inventors: Akihiko ARIKAWA, Tokyo (JP); Takeshi NISHINO, Tokyo (JP)

(73) Assignee: FCL COMPONENTS LIMITED, Tokyo (JP)

(21) Appl. No.: 19/349,204

(22) Filed: Oct. 3, 2025

(30) Foreign Application Priority Data
Oct. 10, 2024 (JP) 2024-178267

(51) Int. Cl. H01H 13/702; H01H 13/14

(52) U.S. Cl. CPC H01H 13/702; H01H 13/14

(57) ABSTRACT

A keyboard includes a sliding member, a first elastic member that elastically buckles and deforms, a second elastic member that opens and closes an electrical contact, a support member that guides the sliding member, a membrane sheet having a first surface pressed by the second elastic member and a second surface including a conductive member, a printed circuit board that faces the second surface, and includes a controller having an output port and a reception port, a first contact connected to the output port, a second contact connected to the reception port, and a diode connected between the reception port and the second contact, and a spacer that forms a space between the membrane sheet and the printed circuit board, wherein the conductive member is in contact with the first contact and the second contact in accordance with sliding of the sliding member.

### CROSS-REFERENCE TO RELATED APPLICATION

This application is based upon and claims the benefit of priority of the prior Japanese Patent Application No. 2024-178267 filed on October 10, 2024, the entire contents of which are incorporated herein by reference.

### FIELD

A certain aspect of the embodiments is related to a keyboard and a console device.

### BACKGROUND

Conventionally, there has been known a keyboard that includes a rubber which gives a user a feeling of clicking a key and a spring which opens and closes a contact, and that can turn on a contact in a membrane switch by the spring pressing down the membrane switch during key click. In this keyboard, the membrane switch can be turned on during the key click, and a good feeling can be provided to the user without causing deviation between the operation feeling and ON-operation of the contact point.

In recent years, the use of keyboards in games has increased, and games that are operated by simultaneously pressing a plurality of keys have increased, and simultaneous pressing of the plurality of keys is essential for playing a game.

When three or more keys are pressed simultaneously, a phenomenon known as ghost input occurs, in which an electrical current flows in an unintended direction in the circuitry of the keyboard. Note that the technique related to the present disclosure is disclosed in Japanese Laid-open Patent Publication No. 2011-249282, Japanese Laid-open Patent Publication No. H4-277424, and Japanese Laid-Open Utility Model Publication No. H10-000237.

### SUMMARY

According to an aspect of the present disclosure, there is provided a keyboard including: a sliding member that is slidable by pressing operation of an operation member; a first elastic member that is attached to the sliding member and elastically buckles and deforms in accordance with the pressing operation of the operation member; a second elastic member that is attached to the sliding member and opens and closes an electrical contact in accordance with sliding of the sliding member; a support member that guides the sliding member; a membrane sheet having a first surface pressed by the second elastic member and a second surface provided opposite to the first surface, the second surface including a conductive member; a printed circuit board that faces the second surface of the membrane sheet, the printed circuit board including: a controller having an output port and a reception port, a first contact connected to the output port, a second contact connected to the reception port, and a diode connected between the reception port and the second contact; and a spacer that forms a space between the membrane sheet and the printed circuit board; wherein the electrical contact includes the conductive member, the first contact, and the second contact, and the conductive member is in contact with the first contact and the second contact in accordance with sliding of the sliding member.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a perspective view of a keyboard according to an embodiment.

FIG. 1B is a perspective view of a console device having the keyboard according to the present embodiment.

FIG. 2A is an exploded perspective view illustrating each component of a switch unit.

FIG. 2B is a perspective view of the integrated switch unit.

FIG. 3A is a plan view illustrating a front side of a key top.

FIG. 3B is a cross-sectional view taken along a line A-A of FIG. 3A.

FIG. 3C is a cross-sectional view taken along a line B-B of FIG. 3A.

FIG. 3D is a plan view illustrating a back side of the key top.

FIG. 4A is a plan view of a slider as viewed from above.

FIG. 4B is a cross-sectional view taken along a line A-A of FIG. 4A.

FIG. 4C is a cross-sectional view taken along a line B-B of FIG. 4A.

FIG. 4D is a perspective view of the slider.

FIG. 5A is a plan view of a housing as viewed from above.

FIG. 5B is a cross-sectional view taken along a line A-A of FIG. 5A.

FIG. 5C is a cross-sectional view taken along a line B-B of FIG. 5A.

FIG. 5D is a perspective view of the housing.

FIG. 6A is a plan view of a key switch assembly as viewed from above.

FIG. 6B is a cross-sectional view taken along a line A-A of FIG. 6A.

FIG. 6C is a cross-sectional view taken along a line B-B of FIG. 6A.

FIG. 7 is a diagram illustrating a depression characteristic of the key switch assembly.

FIGS. 8A to 8D are cross-sectional views illustrating examples of configuration of a membrane sheet, a spacer, and a printed circuit board.

FIG. 9A is a perspective view of the membrane sheet, the spacer, and the printed circuit board.

FIG. 9B is a plan view illustrating a positional relationship between an electrical contact and an LED.

FIG. 10A is a block diagram illustrating a connection relation between a printed circuit board and a computer.

FIG. 10B is a circuit diagram of a keyboard controller and a switch matrix included in the printed circuit board.

### DESCRIPTION OF EMBODIMENTS

In the keyboard of Japanese Laid-open Patent Publication No. 2011-249282, a membrane switch is used, and when three or more keys are simultaneously pressed, there is a possibility that a ghost input, in which a current flows in an unintended direction, occurs.

Therefore, it is conceivable to mount diodes for avoiding the ghost input on the membrane switch. However, the membrane switch has a structure in which films on which contacts are printed face each other with spacers interposed therebetween, and it is not easy to mount the diodes for avoiding the ghost input on one of the films, and the manufacturing cost increases. In addition, since each of the diodes has a height greater than the distance between the upper film and the lower film of the membrane switch, it is physically difficult to dispose the diodes between the upper film and the lower film.

The present disclosure provides a keyboard and a console device that can provide a user with a good feeling and can accurately detect the simultaneous pressing of a plurality of keys.

According to an aspect of the present disclosure, it is possible to provide a user with a good feeling and accurately detect simultaneous pressing of a plurality of keys.

Hereinafter, embodiments of the present disclosure will be described with reference to the drawings.

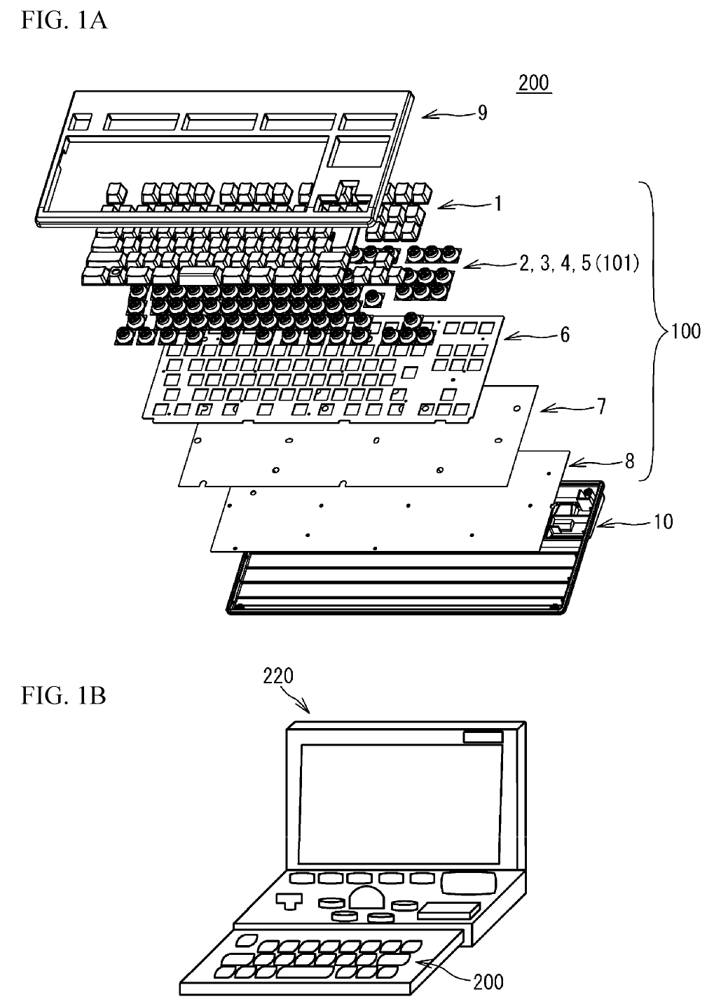

FIG. 1A is a perspective view of a keyboard according to the present embodiment. FIG. 1B is a perspective view of a console device having the keyboard according to the present embodiment.

As illustrated in FIG. 1A, a keyboard 200 includes an upper cover 9, a lower cover 10, and a key switch assembly 100. The key switch assembly 100 includes a key top 1 (operation member), a slider 2 (sliding member), a dome rubber 3 (first elastic member), a spring 4 (second elastic member), a housing 5 (support member), a switch panel 6, a membrane sheet 7 and a printed circuit board 8. The slider 2, the dome rubber 3, the spring 4, and the housing 5 constitute a switch unit 101. In the keyboard 200, the switch panel 6, the membrane sheet 7, and the printed circuit board 8 in the key switch assembly 100 are formed to be enlarged in the horizontal direction over the entire keyboard, and are shared by the plurality of switch units 101.

As illustrated in FIG. 1B, a console device 220 such as a machine tool, a medical device, a ticket machine, an ATM, or a kiosk terminal may include the keyboard 200 according to the present embodiment as an input device.

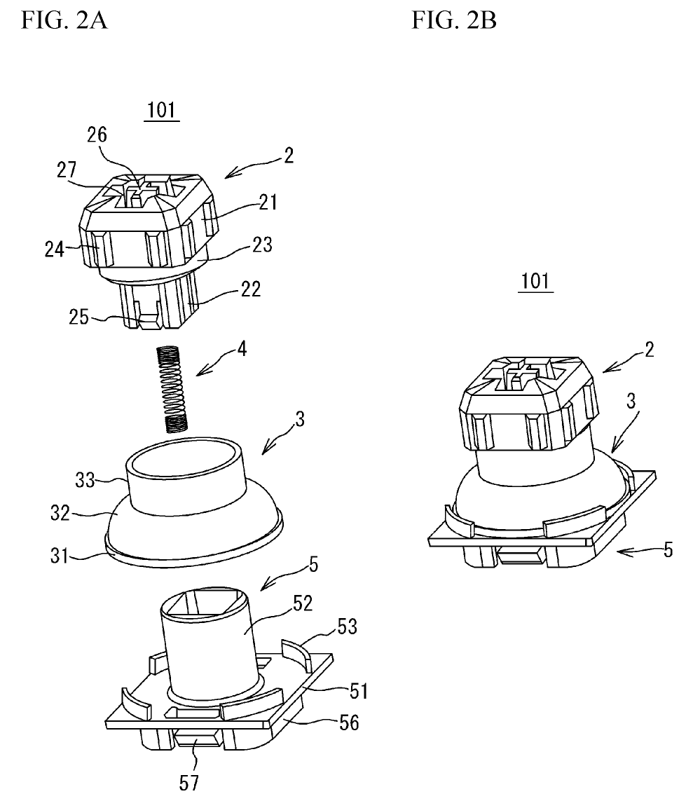

FIG. 2A is an exploded perspective view illustrating each component of the switch unit 101, and FIG. 2B is a perspective view of the integrated switch unit 101.

The switch unit 101 of FIG. 2A includes the slider 2 to which the key top 1 can be attached, the dome rubber 3 that is elastically buckled and deformed by the pressing operation of the key top 1 and applies a repulsive force corresponding to the elastic buckling deformation to the slider 2, the spring 4 that is attached to the slider 2 and presses down an electrical contact such as a membrane switch or a mechanical switch (not illustrated), and the housing 5 to which the slider 2 is attached and which guides the slider 2 to slide in the vertical direction.

In the switch unit 101, the spring 4 is fixed inside a column portion 22 of the slider 2, and the dome rubber 3 is interposed between the slider 2 and the housing 5, so that the slider 2 is engaged with the housing 5 so as to be slidable up and down. As a result, the slider 2, the dome rubber 3, the spring 4, and the housing 5 included in the switch unit 101 are integrated as illustrated in FIG. 2B.

The dome rubber 3 is a dome-shaped member integrally molded from a rubber material, and includes a ring-shaped base portion 31, a dome portion 32 rising from the base portion 31 in a dome shape, and a cylindrical portion 33 extending upward from a top portion of the dome portion 32. The cylindrical portion 33 is press-fitted from below onto the outer peripheral surface 23 of the slider 2, and is mounted on the outer peripheral surface 23. The dome portion 32 of the dome rubber 30 is deformed in accordance with the sliding of the slider 2 in the vertical direction.

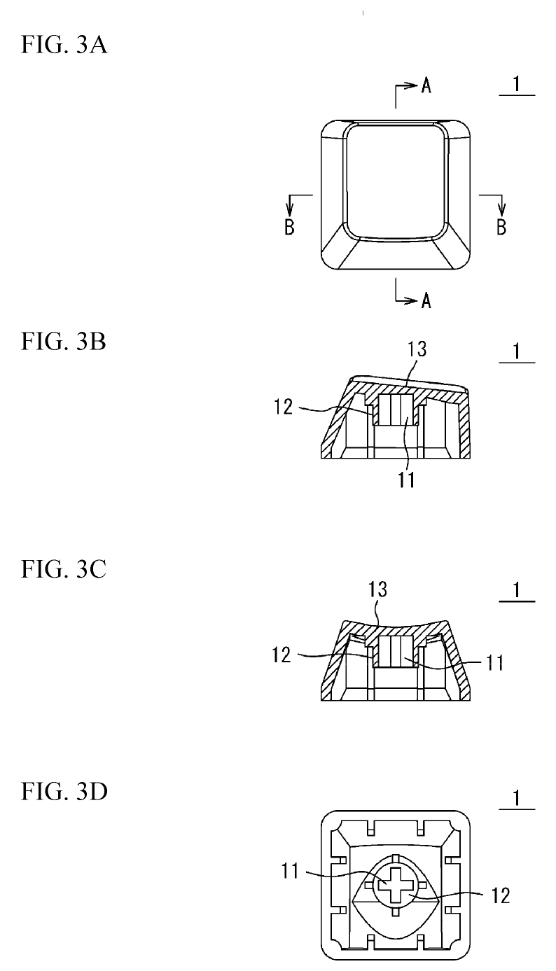

FIG. 3A is a plan view illustrating the front side of the key top 1. FIG. 3B is a cross-sectional view taken along a line A-A of FIG. 3A. FIG. 3C is a cross-sectional view taken along a line B-B of FIG. 3A. FIG. 3D is a plan view illustrating the back side of the key top 1.

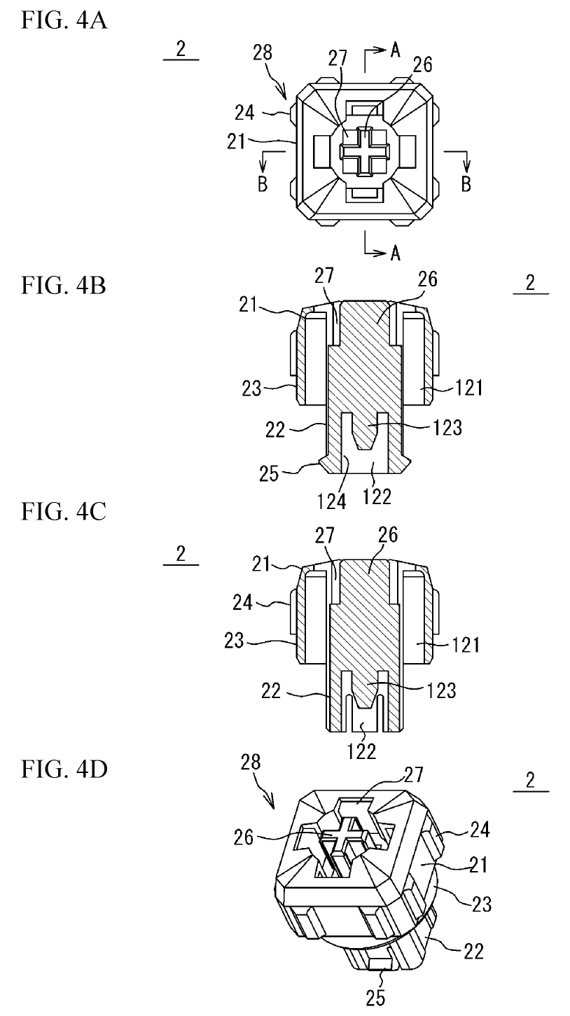

The key top 1 is formed by integral molding using a resin as a constituent material. As illustrated in FIGS. 3B to 3D, a protrusion 12 protruding downward from an upper surface 13 of the key top 1 is provided on the back surface of the key top 1. The protrusion 12 has a recess 11 for attachment to a cross-shaped protrusion 26 (see FIGS. 2A and 2B and FIGS. 4A to 4D) of the slider 2.

FIG. 4A is a plan view of the slider 2 as viewed from above. FIG. 4B is a cross-sectional view taken along a line A-A of FIG. 4A. FIG. 4C is a cross-sectional view taken along a line B-B of FIG. 4A. FIG. 4D is a perspective view of the slider 2.

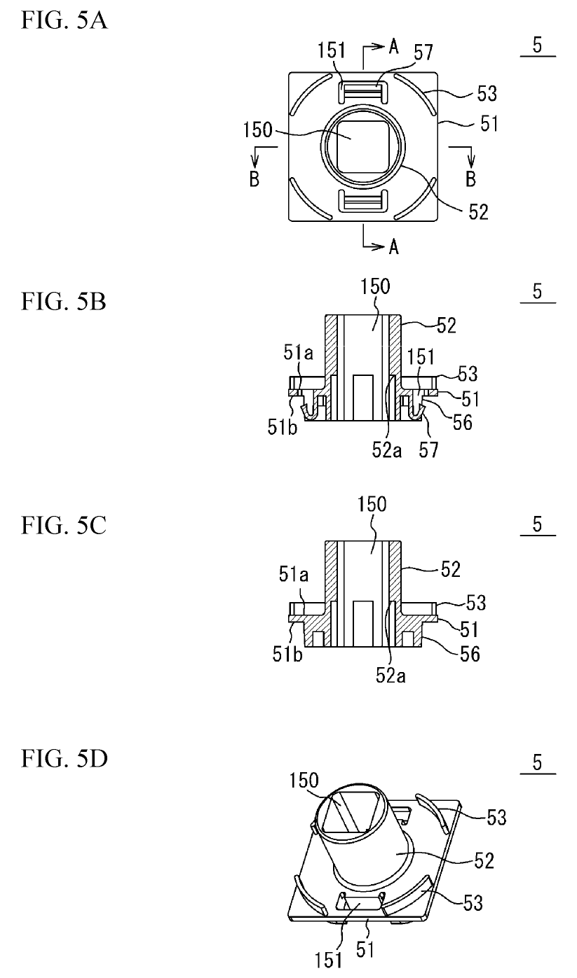

The slider 2 has a main body 21 and the column portion 22 extending from the main body 21 toward the housing 5. The column portion 22 is formed so as to have a substantially square cross-sectional shape. The column portion 22 has a locking claw 25 for slidably locking the slider 2 to the housing 5. The locking claw 25 engages with a step 52a (see FIGS. 5B and 5C) on the inside wall of a guide 52 of the housing 5. The outer periphery of the main body 21 is provided with protrusions 24 for engaging with the key top 1 and the outer peripheral surface 23 into which the dome rubber 3 is press-fitted. Further, a space 121 for receiving the guide 52 of the housing 5 is provided between the main body 21 and the column portion 22.

A ceiling portion 28 which is the upper end of the slider 2 includes a recess 27 for accommodating the protrusion 12 having the cross-shaped recess 11 of the key top 1, and the cross-shaped protrusion 26 for fitting into the cross-shaped recess 11 of the key top 1. The depth of the recess 27 is equal to or larger than the height of the protrusion 12 of the key top 1. Thus, even when the cross-shaped protrusion 26 is provided at the upper end of the slider 2, it is possible to suppress an increase in the overall height of the key switch assembly 100.

The column portion 22 has an opening 122 at the bottom, and a protrusion 123 for fixing the spring 4 is provided inside the column portion 22. A part of the spring 4 is inserted and fixed between the inner surface 124 of the column portion 22 and the protrusion 123.

The slider 2 and the housing 5 are formed of different materials having low friction at the time of contact. For example, the slider 2 is formed of a POM resin (polyacetal resin), and the housing 5 is formed of an ABS resin (thermoplastic resin formed by polymerizing three monomers of acrylonitrile, butadiene, and styrene). This is because if the slider 2 and the housing 5 are formed of the same material, the slider 2 bites into the guide 52 during sliding, and a stack occurs in which the key top 1 does not move. For this reason, the slider 2 and the housing 5 are formed of different materials having low friction at the time of contact. The materials of the slider 2 and the housing 5 are not limited to resins. In order to reduce friction at the time of contact, a process for reducing a friction coefficient may be performed on a portion where the slider 2 and the housing 5 come into contact with each other.

FIG. 5A is a plan view of the housing 5 as viewed from above. FIG. 5B is a cross-sectional view taken along a line A-A in FIG. 5A. FIG. 5C is a cross-sectional view taken along a line B-B in FIG. 5A. FIG. 5D is a perspective view of the housing 5.

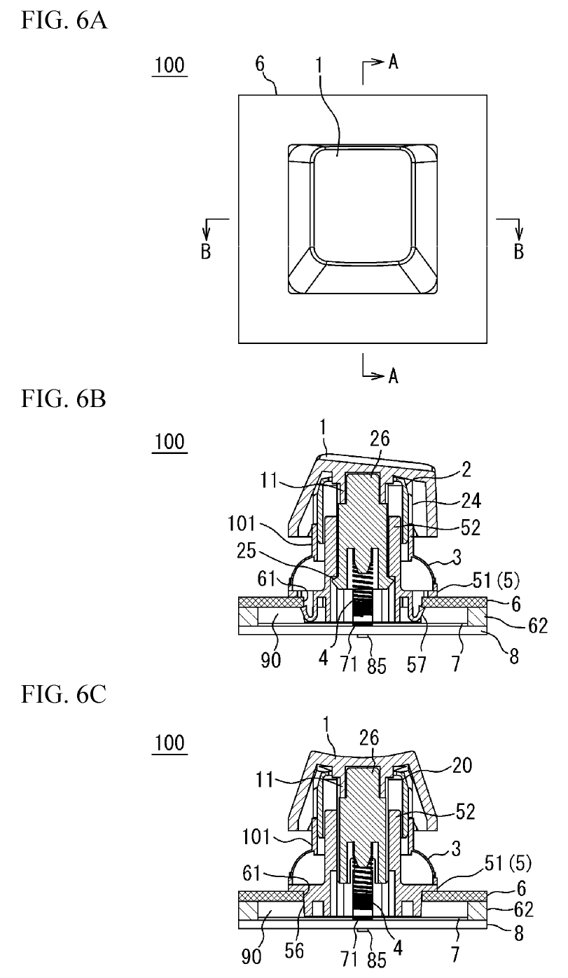

The housing 5 is a member that supports the slider 2 and the dome rubber 3, and includes a square plate portion 51 that constitutes a base substrate. The housing 5 includes the guide 52 (first guide) that stands upright from the center of a front surface 51a of the plate portion 51 and guides the slider 2, a protrusion portion 53 (second guide) that stands on the front surface 51a of the plate portion 51, is provided outside the guide 52 when the plate portion 51 is viewed from above, and guides the dome rubber 3, and a leg portion 56 that stands on a back surface 51b of the plate portion 51 and is mountable to an opening 61 (see FIGS. 6B and 6C) of the switch panel 6 (mounted member). The leg portion 56 includes claw portions 57 that interpose the switch panel 6 between the claw portions 57 and the back surface 51b of the plate portion 51. When the leg portion 56 alone may be sufficient for fixing to the switch panel 6, the leg portion 56 does not necessarily have to include the claw portions 57. Openings 151 are provided at positions of the plate portion 51 above the claw portions 57. This allows the user to check from above whether the switch panel 6 is interposed between the claw portions 57 and the back surface 51b of the plate portion 51. The number of the claw portions 57 is not limited to two, and may be four.

A through hole 150 having a substantially rectangular cross section for inserting the column portion 22 of the slider 2 is formed at the center of the guide 52.

FIG. 6A is a plan view of a key switch assembly according to a second embodiment as viewed from above. FIG. 6B is a cross-sectional view taken along a line A-A in FIG. 6A. FIG. 6C is a cross-sectional view taken along a line B-B in FIG. 6A.

The key switch assembly 100 includes the switch unit 101 including the slider 2, the dome rubber 3, the spring 4, and the housing 5, the key top 1 that is mounted on the switch unit 101 and is pressed downward, the switch panel 6 that is a positioning member for positioning the housing 5, the membrane sheet 7 disposed below the housing 5 and the switch panel 6, and the printed circuit board 8 disposed below the membrane sheet 7. The printed circuit board 8 includes diodes 85 described later.

The membrane sheet 7 and the printed circuit board 8 are provided with electrical contacts 71. Each of the electrical contacts 71 is disposed below the housing 5 and the switch panel 6, and is closed when a predetermined pressing force is applied from the spring 4 by pressing the key top 1.

The switch panel 6 is disposed on the membrane sheet 7 and the printed circuit board 8, and is fixed to the printed circuit board 8 by screws or the like (not illustrated) via spacers 62 provided under the switch panel 6. The shape of the opening 61 of the switch panel 6 is square in plan view, and when the leg portion 56 of the housing 5 is mounted to the opening 61, the opening 61 is covered with the plate portion 51 of the housing 5. A space 90 having a predetermined height is formed between the switch panel 6 and the membrane sheet 7 by the spacers 62.

When the space 90 having a predetermined height equal to the height of the leg portion 56 is formed, the key switch assembly 100 can be configured without providing the switch panel 6 by attaching the lower portion of the housing 5 to the upper surface of the membrane sheet 7 with a double-sided tape or the like.

When the user presses the key top 1, the column portion 22 of the slider 2 slides with respect to the through hole 150 of the guide 52, and thus the slider 2 moves downward. The dome rubber 3 is deformed outward by the movement of the slider 2. The spring 4 attached to the slider 2 is brought into contact with the membrane sheet 7 by the movement of the slider 2, and the membrane sheet 7 is pressed by the compression of the spring 4, so that the electric contact 71 is turned on.

When the user releases the finger from the key top 1, the slider 2 returns to the original position by the elastic force of the dome rubber 3 and the spring 4. In the membrane sheet 7, the pressing force of the key top 1 is reduced, and the electrical contact 71 is turned off.

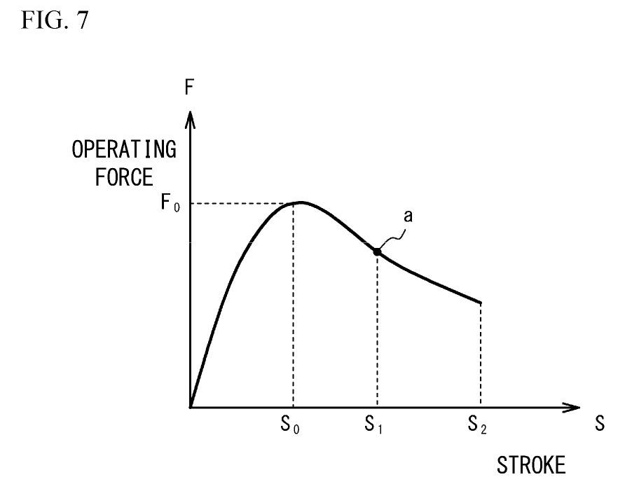

FIG. 7 is a diagram illustrating a depression characteristic of the key switch assembly 100. A horizontal axis represents a stroke S (depression amount) of the key top 1, and a vertical axis represents an operating force (depression force) F. A point “a” in FIG. 7 indicates that the electrical contact 71 is on.

As illustrated in FIG. 7, when the operating force F of the key top 1 increases, the stroke S also increases accordingly. At this time, the dome rubber 3 is elastically deformed, and a reaction force from the dome rubber 3 acts on the key top 1. The depression characteristic in this case is equal to a load displacement characteristic of the dome rubber 3 itself, and the operating force F increases until the load acting on the dome rubber 3 reaches the buckling load of the dome rubber 3, and when the load reaches the buckling load, the operating force F gently decreases with the increase in the stroke S. A peak operating force F0 is obtained by the elastic buckling deformation of the dome rubber 3, and thus the user can obtain a click feeling peculiar to the keying operation.

In the present embodiment, a stroke S1 at the time of contact-ON is set to a value (for example, an intermediate value between S0 and S2) which is larger than a stroke S0 at which the peak operating force F0 is generated and smaller than an end stroke S2. As described above, in the key switch assembly 100, the spring 4 opens and closes the electrical contact 71 while the operating force F generated at the time of the buckling deformation of the dome rubber 3 is decreasing, and therefore, deviation does not occur between the operation feeling and the contact-ON operation, and a good feeling can be provided to the user.

In the switch unit 101, the area of the plate portion 51 is larger than the area of the opening 61 of the switch panel 6 in plan view. Therefore, the plate portion 51 of the housing 5 is in contact with the peripheral portion of the opening 61 of the switch panel 6, and the leg portion 56 of the housing 5 can be mounted to the opening 61 of the switch panel 6. The housing 5 can be prevented from entirely sinking into the opening 61 of the switch panel 6.

When the diameter of the base portion 31 of the dome rubber 3 is larger than the length of one side of the plate portion 51 of the housing 5, the base portion 31 of the dome rubber 3 protrudes from the plate portion 51 of the housing 5, and thus it is difficult to obtain the depression characteristic of the key switch assembly 100 of FIG. 7. When the diameter of the base portion 31 of the dome rubber 3 is smaller than 70% of the length of one side of the plate portion 51 of the housing 5, the size of the dome rubber 3 is reduced, and it is difficult to obtain the depression characteristic of the key switch assembly 100 of FIG. 7. Therefore, the diameter of the base portion 31 of the dome rubber 3 is preferably 70% or more and 100% or less of the length of one side of the plate portion 51 of the housing 5. In particular, by setting the diameter of the base portion 31 of the dome rubber 3 and the length of one side of the plate portion 51 of the housing 5 to the same length, the size of the dome rubber 3 increases, so that the depression characteristic of the key switch assembly 100 of FIG. 7 is easily obtained, and the housing 5 can hold the dome rubber 3.

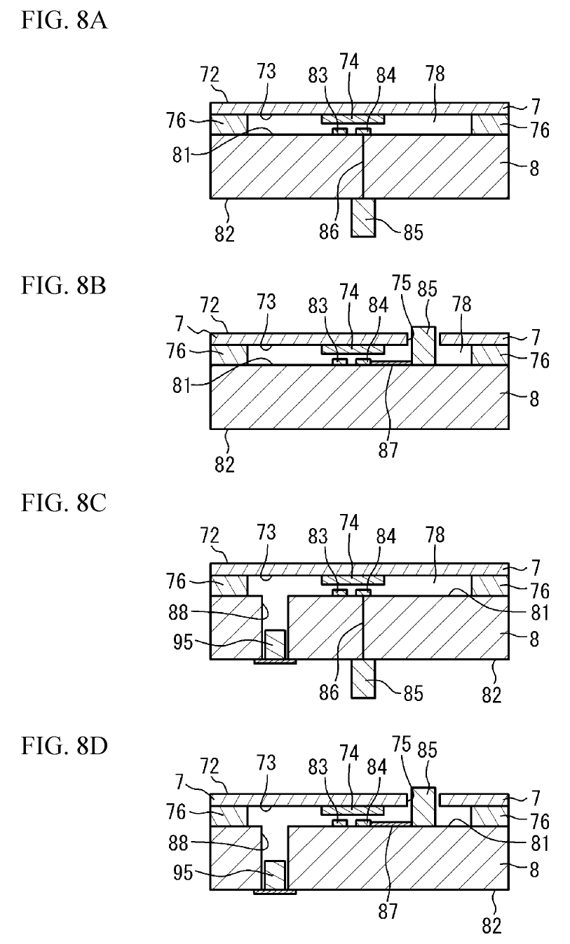

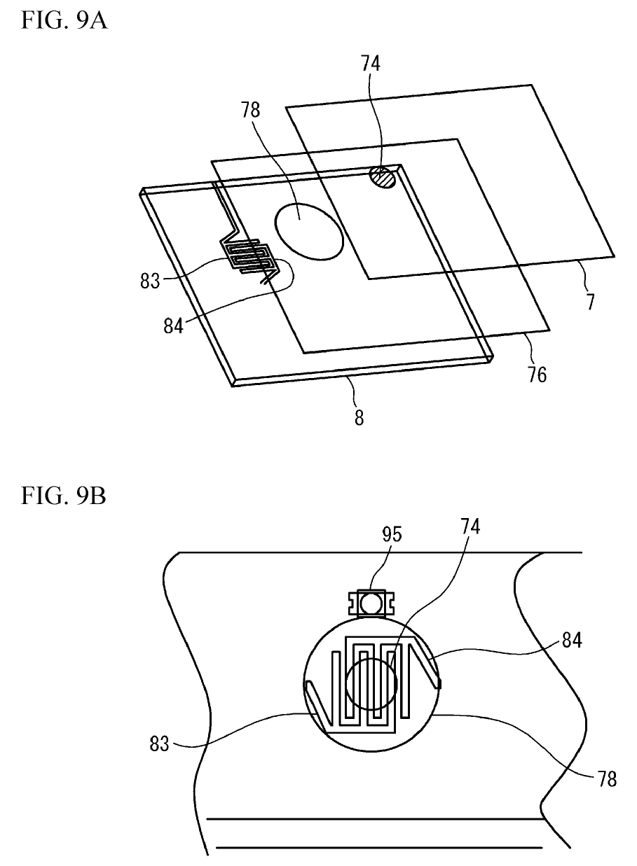

FIGS. 8A to 8D are cross-sectional views illustrating examples of configuration of the membrane sheet 7, the spacer 76, and the printed circuit board 8. FIG. 8A is a view illustrating a state in which the diode 85 is provided on a lower surface 82 of the printed circuit board. FIG. 8B is a view illustrating a state in which the diode 85 is provided on an upper surface 81 of the printed circuit board. FIG. 8C is a view illustrating a state in which an LED 95 is provided in FIG. 8A. FIG. 8D is a view illustrating a state in which the LED 95 is provided in FIG. 8B. FIG. 9A is a perspective view of the membrane sheet 7, the spacer 76, and the printed circuit board 8. FIG. 9B is a plan view illustrating a positional relationship between the electrical contact 71 and the LED 95. FIGS. 8A to 8D illustrate the configurations of the membrane sheet 7 and the printed circuit board 8 corresponding to one switch unit 101. Therefore, in the keyboard 200 of FIG. 1A, the configurations of the membrane sheet 7 and the printed circuit board 8 of FIGS. 8A to 8D are arranged for each key switch assembly 100 or each switch unit 101.

The spacers 76 are provided to form a space 78 between the membrane sheet 7 and the printed circuit board 8. As illustrated in FIGS. 8A and 8C, the membrane sheet 7 includes an upper surface 72 (first surface) pressed down by the spring 4 in accordance with the sliding of the slider 2, and a lower surface 73 (second surface) that is provided opposite to the upper surface 72 and includes island-shaped conductive members 74. One island-shaped conductive member 74 is printed on the lower surface 73 for one switch unit 101, and when the membrane sheet 7 is pressed down by the spring 4, the conductive member 74 bridges a first contact 83 and a second contact 84 of the printed circuit board 8. Therefore, when the membrane sheet 7 is pressed down by the spring 4, a current flows from the first contact 83 to the second contact 84 via the conductive member 74, or from the second contact 84 to the first contact 83 via the conductive member 74. The size of the conductive member 74 is a size capable of bridging the first contact 83 and the second contact 84 of the printed circuit board 8, and the shape of the conductive member 74 is not particularly limited. No wiring pattern is connected to the island-shaped conductive member 74, and the island-shaped conductive member 74 is isolated from the adjacent conductive member 74. Since only the island-shaped conductive members 74 are formed on the lower surface 73 of the membrane sheet 7 and it is not necessary to provide a wiring pattern on the membrane sheet 7, the manufacturing cost can be reduced.

In FIGS. 8A and 8C, the diode 85 is provided on the lower surface 82 of the printed circuit board 8, and in FIGS. 8B and 8D, the diode 85 is provided on the upper surface 81 of the printed circuit board 8. The configurations of FIGS. 8C and 8D are the same as those of FIGS. 8A and 8B, respectively, except that the LED (Light Emitting Diode) 95 (illumination device) is provided.

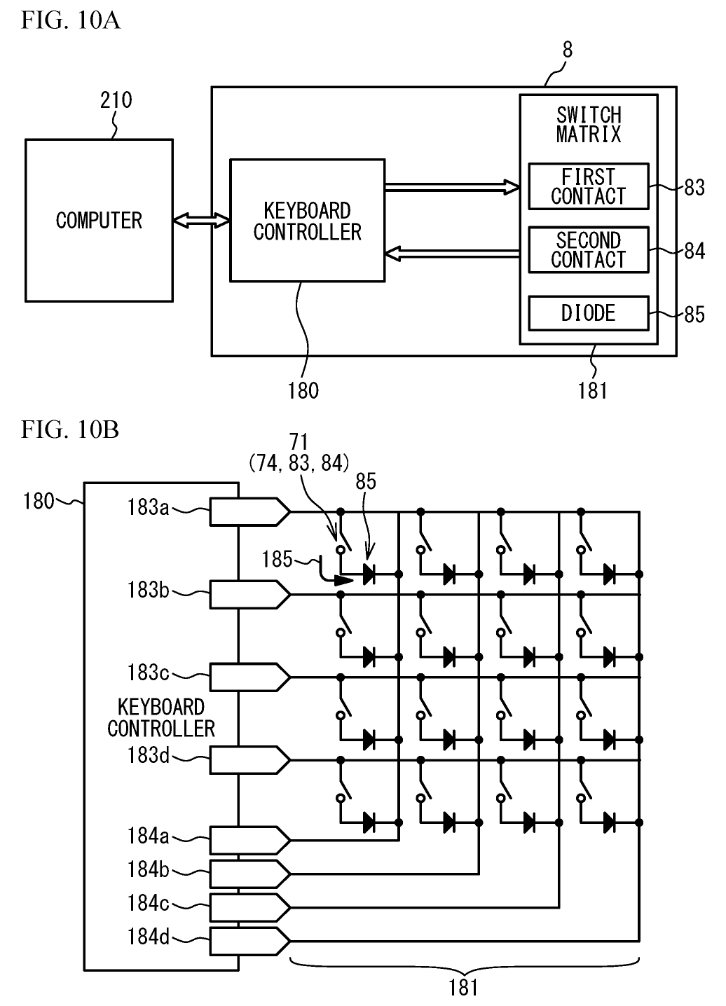

As illustrated in FIGS. 8A and 8C, the printed circuit board 8 has the upper surface 81 (third surface) facing the lower surface 73 of the membrane sheet 7, and the lower surface 82 (fourth surface) provided opposite to the upper surface 81. The first contacts 83 connected to output ports 183a to 183d (see FIG. 10B) of the keyboard controller 180, and the second contacts 84 connected to reception ports 184a to 184d (see FIG. 10B) of the keyboard controller 180 are formed on the upper surface 81. The lower surface 82 is provided with the diodes 85 connected between the reception ports 184a to 184d (see FIG. 10B) of the keyboard controller 180 and the second contacts 84. The second contact 84 and the diode 85 are connected by a via wiring 86 penetrating the printed circuit board 8. The first contact 83 and the second contact 84 face each other via the space 78, and when the membrane sheet 7 is pressed down by the spring 4, the conductive member 74 is in contact with the first contact 83 and the second contact 84. The conductive member 74, the first contact 83, and the second contact 84 are formed of a conductive ink paste such as carbon or silver, and constitute the electrical contact 71 described above. The first contact 83 and the second contact 84 may be formed of a copper foil or metal plating.

For example, the thickness of the membrane sheet 7 is 70 μm to 100 μm, and the height of the spacer 76, that is, the interval between the membrane sheet 7 and the printed circuit board 8 is 100 to 150 μm. For example, the thickness of the diode 85 is 0.3 to 0. 8 mm (300 to 800 μm). For example, the thickness of each of the conductive member 74, the first contact 83, and the second contact 84 is 5 to 10 μm. For example, the thickness of the printed circuit board 8 is 1 to 2 mm, and the thickness of the LED 95 is 0.3 to 0. 8 mm.

As described above, since the diode 85 has a thickness larger than the height of the spacer 76, that is, the interval between the membrane sheet 7 and the printed circuit board 8, it is physically difficult to dispose the diode 85 between the membrane sheet 7 and the printed circuit board 8. Therefore, it is conceivable to make the interval between the membrane sheet 7 and the printed circuit board 8 larger than the thickness of the diode 85. However, when the interval between the membrane sheet 7 and the printed circuit board 8 is made larger than the thickness of the diode 85, the depression characteristic (the relationship between the key stroke and the load) of the key switch assembly 100 of FIG. 7 changes, and a good feeling cannot be provided to the user.

Therefore, as illustrated in FIGS. 8A and 8C, by providing the diode 85 on the lower surface 82 of the printed circuit board 8, it is possible to avoid the ghost input due to simultaneous pressing of the plurality of keys while providing a good feeling to the user.

As illustrated in FIGS. 8B and 8D, the diode 85 and a wiring 87 connecting the second contact 84 and the diode 85 may be provided on the upper surface 81 of the printed circuit board 8. In this case, the membrane sheet 7 has a first through hole 75 through which the diode 85 penetrates at a position facing the diode 85. In the case where the membrane sheet 7 has the first through holes 75, even if the diode 85 is provided on the upper surface 81 of the printed circuit board 8, it is not necessary to change the interval between the membrane sheet 7 and the printed circuit board 8, and therefore, it is possible to avoid the ghost input due to simultaneous pressing of the plurality of keys while providing a good feeling to the user.

As illustrated in FIGS. 8C and 8D, the printed circuit board 8 may have a second through hole 88 penetrating the printed circuit board 8, and the LED 95 may be disposed in the second through hole 88. The LED 95 may be electrically connected to a wiring (not illustrated) on the lower surface 82 of the printed circuit board 8, and may be turned on and off. This can improve the aesthetic appearance of the keyboard 200 by illumination. Further, since the printed circuit board 8 is adopted instead of the lower film of the membrane switch, the mounting of the LED 95 is facilitated.

The membrane sheet 7 is formed of, for example, a transparent PET (polyethylene terephthalate) film having a transmittance of 50% or more. When a transparent PET film having a transmittance of 90% or more is used, the upper surface 72 of the membrane sheet 7 may be subjected to white printing to diffuse milky white light upward.

FIG. 10A is a block diagram illustrating a connection relationship between the printed circuit board 8 and a computer 210, and FIG. 10B is a circuit diagram of the keyboard controller 180 and a switch matrix 181 included in the printed circuit board 8.

As illustrated in FIG. 10A, the printed circuit board 8 includes the keyboard controller 180 and the switch matrix 181, and the printed circuit board 8 is connected to the computer 210 which is an external device. The keyboard controller 180 is configured by an IC (integrated circuit) or a microcomputer, recognizes a pressed key, and transmits a key code corresponding to the pressed key to the computer 210. The keyboard controller 180 returns information on the type of the keyboard 200 to the computer 210 in response to a request from the computer 210. The switch matrix 181 includes the first contact 83, the second contact 84, and the diode 85 for each switch unit 101.

As illustrated in FIG. 10B, the keyboard controller 180 includes the output ports 183a to 183d for outputting the drive current to the switch matrix 181, and the reception ports 184a to 184d for receiving the current corresponding to ON or OFF of the electrical contact 71 from the switch matrix 181. The number of output ports and the number of reception ports are not limited to the example of FIG. 10B. For example, when the electrical contact 71 illustrated in FIG. 8B is turned on, the drive current from the output port 183a flows along a path 185 through the diode 85 to the receiver port 184a. Even if the plurality of electric contacts are simultaneously turned on, the sneak current is avoided by the diodes 85, so that the ghost input can be avoided.

The keyboard 200 corresponds to an N-key rollover (N = an integer of 2 or more) in which, when a plurality of keys are pressed at the same time, all key inputs are recognized according to the order of pressing.

As described above, according to the present embodiment, the keyboard 200 includes the slider 2 that is slidable by the pressing operation of the key top 1, the dome rubber 3 that is mounted on the slider 2 and elastically buckles and deforms in accordance with the pressing operation of the key top 1, the spring 4 that is mounted on the slider 2 and opens and closes the electrical contact 71 in accordance with the sliding of the slider 2, the housing 5 that guides the slider 2, the membrane sheet 7, the printed circuit board 8, and the spacers 76 that form a space between the membrane sheet 7 and the printed circuit board 8. Further, the membrane sheet 7 has the upper surface 72 pressed down by the spring 4 in accordance with the sliding of the slider 2, and the lower surface 73 that is provided opposite to the upper surface 72 and includes the conductive member 74. The printed circuit board 8 includes: the keyboard controller 180 having the output ports 183a to 183d for outputting the drive current and the reception ports 184a to 184d for receiving the current corresponding to the on or off of the electrical contacts 71; the first contacts 83 connected to the reception ports 183a to 183d; the second contacts 84 connected to the reception ports 184a to 184d; and the diodes 85 connected between the reception ports 184a to 184d and the second contacts 84. The printed circuit board 8 faces the lower surface 73 of the membrane sheet 7. When the membrane sheet 7 is pressed down by the spring 4 in accordance with the sliding of the slider 2, the conductive member 74 is in contact with the first contact 83 and the second contact 84, and the conductive member 74, the first contact 83, and the second contact 84 constitute the electrical contact 71.

As described above, in the keyboard 200, unlike a general membrane switch, the lower film of the membrane switch is formed of the printed circuit board 8 having the diode 85, and thus it is possible to avoid the sneak current due to simultaneous pressing of the plurality of keys and to accurately detect the simultaneous pressing of the plurality of keys. Further, since the spring 4 opens and closes the electrical contact 71 during the decrease of the operating force F generated at the time of the buckling deformation of the dome rubber 3, no deviation occurs between the operation feeling and the contact-ON operation, and a good feeling can be provided to the user.

In a normal membrane keyboard, it is necessary to dispose a printed circuit board having a keyboard controller for transmitting a key code corresponding to a pressed key to a computer under a membrane switch including an upper film, a lower film, and spacers. In contrast, in the present embodiment, the lower film of the membrane switch is not provided. Therefore, the number of components can be reduced as compared with the normal membrane keyboard.

When the diode 85 is provided on the upper surface 81 of the printed circuit board 8, the interval between the membrane sheet 7 and the printed circuit board 8 is increased due to the thickness of the diode 85, and thus the depression characteristic of the key switch assembly 100 of FIG. 7 may change, and a good feeling may not be provided to the user. In contrast, as illustrated in FIGS. 8A and 8C, when the diode 85 is provided on the lower surface 82 of the printed circuit board 8, it is not necessary to change the interval between the membrane sheet 7 and the printed circuit board 8, and thus it is possible to provide a good feeling to the user without changing the depression characteristic of the key switch assembly 100 of FIG. 7.

As illustrated in FIGS. 8B and 8D, by providing the first through hole 75 through which the diode 85 penetrates in the membrane sheet 7, even when the diode 85 is provided on the upper surface 81 of the printed circuit board 8, it is not necessary to change the interval between the membrane sheet 7 and the printed circuit board 8, and thus, it is possible to provide a good feeling to the user without changing the depression characteristic of the key switch assembly 100 of FIG. 7.

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A keyboard comprising:
a sliding member that is slidable by pressing operation of an operation member;
a first elastic member that is attached to the sliding member and elastically buckles and deforms in accordance with the pressing operation of the operation member;
a second elastic member that is attached to the sliding member and opens and closes an electrical contact in accordance with sliding of the sliding member;
a support member that guides the sliding member;
a membrane sheet having a first surface pressed by the second elastic member and a second surface provided opposite to the first surface, the second surface including a conductive member;
a printed circuit board that faces the second surface of the membrane sheet,
the printed circuit board including:
a controller having an output port and a reception port,
a first contact connected to the output port,
a second contact connected to the reception port, and
a diode connected between the reception port and the second contact; and
a spacer that forms a space between the membrane sheet and the printed circuit board;
wherein the electrical contact includes the conductive member, the first contact, and the second contact, and
the conductive member is in contact with the first contact and the second contact in accordance with sliding of the sliding member.

2. The keyboard according to claim 1, wherein
the printed circuit board has a third surface facing the second surface of the membrane sheet and a fourth surface provided opposite to the third surface, and
the first contact and the second contact are provided on the third surface, and the diode is provided on the fourth surface.

3. The keyboard according to claim 1, wherein
the printed circuit board has a third surface facing the second surface of the membrane sheet,
the first contact, the second contact, and the diode are provided on the third surface, and
the membrane sheet has a first through hole through which the diode penetrate, at a position facing the diode.

4. The keyboard according to claim 1, wherein
the printed circuit board has a third surface facing the second surface of the membrane sheet, a fourth surface provided opposite to the third surface, and a second through hole penetrating the printed circuit board, and
the keyboard further includes an illumination device disposed in the second through hole and electrically connected to a wiring provided on the fourth surface.

5. The keyboard according to claim 1, wherein
the conductive member is not connected to a wiring pattern, and the conductive member is isolated from an adjacent conductive member.

6. A console device comprising the keyboard according to claim 1.
